(19) United States
(12) Patent Application Publication
(10) Pub. No.: US 2022/0242086 A1
(43) Pub. Date: Aug. 4, 2022

(54) COMPOSITE MATERIAL VEHICLE COMPONENT CONSTRUCT

(71) Applicant: Teijin Automotive Technologies, Inc., Auburn Hills, MI (US)

(72) Inventors: Hugh Foran, Auburn Hills, MI (US); Matthew Plauman, Auburn Hills, MI (US); Evan Freeman-Gibb, Auburn Hills, MI (US); Patrick Durham, Auburn Hills, MI (US)

(73) Assignee: Teijin Automotive Technologies, Inc., Auburn Hills, MI (US)

(21) Appl. No.: 17/618,176

(22) PCT Filed: Jun. 11, 2020
(86) PCT No.: PCT/US2020/037172

§ 371 Date: Dec. 10, 2021

Related U.S. Application Data
(60) Provisional application No. 62/859,819, filed on Jun. 11, 2019.

(51) Int. Cl. B32B 3/12; B32B 7/12; B32B 23/08; B32B 27/08; B32B 15/08; B32B 27/06; B32B 27/40; B32B 27/36; B32B 27/20; B32B 5/02; B32B 15/14; B32B 27/12; B32B 23/10; B32B 5/24; B32B 3/08; B32B 5/18; B62D 29/04; B62D 25/12; B62D 25/06; C09J 175/04

(52) U.S. Cl. CPC B32B 3/12; B32B 2307/3065; B32B 23/08; B32B 27/08; B32B 15/08; B32B 27/065; B32B 27/40; B32B 27/36; B32B 27/20; B32B 5/02; B32B 15/14; B32B 27/12; B32B 23/10; B32B 5/245; B32B 3/08; B32B 5/18; B62D 29/043; B62D 25/12; B62D 25/06; C09J 175/04; B32B 2605/08; B32B 2307/406; B32B 2274/00; B32B 2307/4026; B32B 2307/732; B32B 2260/021; B32B 2260/046; B32B 2307/102; B32B 7/12

(57) ABSTRACT

A vehicle component construct including a panel formed of a composite sandwich material. The composite sandwich material including an open area core defining a plurality of pores, a high gloss surface sheet adhered to a first face of the open area core by a first adhesive layer, and a structural skin adhered to a second face of the open area core by a second adhesive layer. The exterior surface of the panel being defined by the high gloss surface sheet of the composite sandwich panel material and the oppositely opposed interior surface of the panel being defined by the structural skin of the composite sandwich material. The vehicle component construct being suitable for use as a body section of a vehicle.

### CROSS-REFERENCE TO RELATED APPLICATION

This application claims priority of U.S. Provisional Patent Application Ser. No. 62/859,819 filed Jun. 11, 2019, which is incorporated herein by reference.

### FIELD OF THE INVENTION

The present invention in general relates to composite materials and in particular to vehicle hood, body, or roof panel components formed with a composite open area core sandwich structure.

### BACKGROUND OF THE INVENTION

Weight savings in the automotive, transportation, and logistics based industries has been a major focus in order to make more fuel efficient vehicles. In order to achieve weight savings in vehicles, light weight composite materials have been introduced to take the place of typical metal structural and surface body components and panels. Composite materials are materials made from two or more constituent materials with significantly different physical or chemical properties, that when combined, produce a material with characteristics different from the individual components. The individual components remain separate and distinct within the finished structure. A composite material may be preferred for many reasons: common examples include materials which are stronger, lighter, or less expensive when compared to traditional materials.

A sandwich-structured composite is a special class of composite material that is fabricated by attaching two thin but stiff skins to a lightweight but thick core. The core material is normally a low strength material, but its higher thickness provides the sandwich composite with high bending stiffness with overall low density. While sandwich structures have previously been developed to provide strength and reduced weight, the ability to obtain a vehicle exterior quality high gloss surface has remained a challenge, regardless of whether the surface outermost layer is thermoset resin or thermoplastic. Exemplary of these efforts are U.S. Pat. Nos. 5,087,500A; 4,803,108A; 8,091,286B2; 4,369,608A; 3,553,054A; and WO2018/202473. It is conventional to either not use such sandwich structures in settings where vehicle high surface gloss is required, for example, hoods, body panels, and roof structures, or resort to an additional outer layer to provide a high gloss outermost layer. Such outermost layers can be applied after structure production or through in mold coatings, both of which add to the cost and complexity of production.

Still another conventional problem with sandwich structures is that the edges are ineffective and allow for infiltration of humidity or moisture that becomes entrained within the core and often inconsistent with finished vehicle surface requirements. With temperature extremes this entrained moisture can reduce the operational lifetime of the structure, while increasing the weight thereof. These problems of moisture infiltration are particularly pronounced in instances when the core is formed of cellulosic materials such as paper. Accordingly, such composite sandwich structures have been unsuitable for forming hoods, body panels, and roof structures given that such areas of a vehicle are exposed to the elements.

Thus, there exists a need for a light weight, high strength vehicle component construct formed of light weight composite materials having formed by streamlined manufacturing processes with increased manufacturing throughputs and reduced costs.

### SUMMARY OF THE INVENTION

The present invention provides a light weight, high strength vehicle component construct formed of light weight composite materials having formed by streamlined manufacturing processes with increased manufacturing throughputs and reduced costs. The inventive vehicle component construct includes a panel formed of a composite sandwich material. The composite sandwich material includes an open area core defining a plurality of pores, a high gloss surface sheet adhered to a first face of the open area core by a first adhesive layer, and a structural skin adhered to a second face of the open area core by a second adhesive layer. According to embodiments, the exterior surface of the panel is defined by the high gloss surface sheet of the composite sandwich panel material and the oppositely opposed interior surface of the panel is defined by the structural skin of the composite sandwich material. The vehicle component construct is suitable for use as a body section of a vehicle.

### BRIEF DESCRIPTION OF THE DRAWINGS

The present invention is further detailed with respect to the following drawings that are intended to show certain aspects of the present invention but should not be construed as a limit on the practice of the present invention.

FIG. 1 is a front perspective view of a vehicle featuring several embodiments of an inventive vehicle component construct;

FIG. 2 is a partial cutaway, perspective view of a composite sandwich panel material used to form embodiments of the inventive component construct;

FIG. 3 is an enlarged partial cutaway, side view of the composite sandwich panel material of FIG. 2 along a line bisecting the hexagonal pores;

FIGS. 4A-4D are cross-sectional views of edges of a composite sandwich panel material;

FIG. 5 is a partial cutaway, perspective view of a composite sandwich panel material having a conduit used to form embodiments of the inventive component construct; and

FIG. 6 is a perspective view of a vehicle component construct according to embodiments of the present invention.

### DESCRIPTION OF THE INVENTION

The present invention has utility as a light weight, high strength hood, body, or roof panel construct formed of light weight composite open area core sandwich structure, formed by streamlined manufacturing processes with increased manufacturing throughputs and reduced costs. The use of the composite sandwich structure allows for replacement of traditional materials such as steel or aluminum, without a loss of strength.

According to embodiments, a hood, body, or roof panel construct is formed of a sandwich composite structure as detailed in co-pending U.S. Provisional Patent Application No. 62/774,600, filed on Dec. 3, 2018, the contents of which are hereby incorporated by reference. As described therein, embodiments of the sandwich composite structure provide a high gloss surface sheet and structural skin that are adhered to the open area core with an adhesive or glue that is viscous when applied. The viscosity of the adhesive as applied allows for contact with the interior volume of the open area core to create more adhesion surface area yet without excessively running into the pores defined in the open area core before the adhesive cured or hardens thereby providing greater adhered contact area between the components of the sandwich composite structure. As a result, reduced delamination of the components of the sandwich composite structure is observed as well as precluding bond line readthrough into the high gloss surface sheet. It is appreciated that providing a high gloss exterior surface without resort to an additional outmost layer requires a balancing of opposing surface tension properties of the composite sandwich panel structures to avoid a loss in tolerances associated with bowing of the structure. Embodiments of the present invention also have utility as watertight and waterproof composite sandwich panel structures.

The present invention will now be described with reference to the following embodiments. As is apparent by these descriptions, this invention can be embodied in different forms and should not be construed as limited to the embodiments set forth herein. Rather, these embodiments are provided so that this disclosure will be thorough and complete, and will fully convey the scope of the invention to those skilled in the art. For example, features illustrated with respect to one embodiment can be incorporated into other embodiments, and features illustrated with respect to a particular embodiment may be deleted from the embodiment. In addition, numerous variations and additions to the embodiments suggested herein will be apparent to those skilled in the art in light of the instant disclosure, which do not depart from the instant invention. Hence, the following specification is intended to illustrate some particular embodiments of the invention, and not to exhaustively specify all permutations, combinations, and variations thereof.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

Unless indicated otherwise, explicitly or by context, the following terms are used herein as set forth below.

As used in the description of the invention and the appended claims, the singular forms “a,” “an” and “the” are intended to include the plural forms as well, unless the context clearly indicates otherwise.

Also as used herein, “and/or” refers to and encompasses any and all possible combinations of one or more of the associated listed items, as well as the lack of combinations when interpreted in the alternative (“or”).

As used herein, the term “high gloss surface” refers to a surface having minimal perceptible surface defects when visually inspected for about three seconds from about 24-28 inches from the viewer and normal to the part surface+/−90 degrees in a well-lit area. That is, the term “high gloss surface” refers to a surface capable of being painted and accepted as a “Class A” autobody part. This is commonly measured by ASTM D523. In the automotive industry, a Class A surface is a surface a consumer can see without functioning the vehicle (e.g., opening the hood or decklid), while a Class A surface finish generally refers to painted outer panels and specifically to the distinctness of image (DOI) and gloss level on the part. It is appreciated that a surface layer may be subjected to sanding, trimming, and priming prior to receiving a paint coating that imparts high gloss, yet must retain dimensionality and adhesion uniformity to primer and paint so as to achieve a high gloss finish.

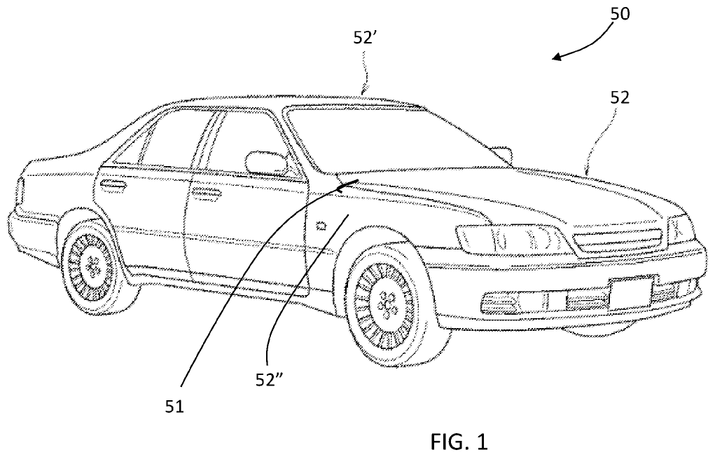

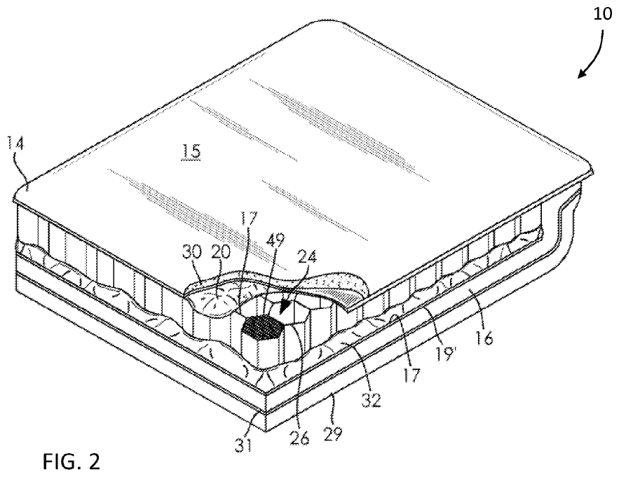

FIG. 1 shows a front perspective view of a vehicle 50 featuring several embodiments of an inventive vehicle component construct 52, 52′, and 52″. According to embodiments, the inventive vehicle component construct is a hood 52, a roof structure 52′, or a body panel 52″. According to embodiments, an inventive vehicle component construct 52, 52′, and 52″ is formed of a composite sandwich panel material 10 as shown in FIG. 2. The composite sandwich panel material 10 includes an open area core 12 with walls 26 defining an ordered array of pores 24 terminating in faces 17 and 17′, a high gloss surface sheet 14 adhered to a first face 17 of the open area core 12 by a first adhesive layer 20, and a structural skin 16 adhered to a second face 17′ of the open area core 12 by a second adhesive layer 22. The high gloss surface sheet 14 has a high gloss finish suitable as an auto body exterior surface. According to embodiments, the exterior surface of the vehicle component construct 52, 52′, and 52″ is defined by the high gloss surface sheet 14 of the composite sandwich panel material 10 and the oppositely opposed interior surface is defined by the structural skin 16 of the composite sandwich panel material 10. Thus, the vehicle component construct 52, 52′, and 52″ is formed as a structural part and simultaneously as a decorative part with no additional high gloss panel separate from the vehicle component construct 52, 52′, and 52″ being needed to complete the vehicle component.

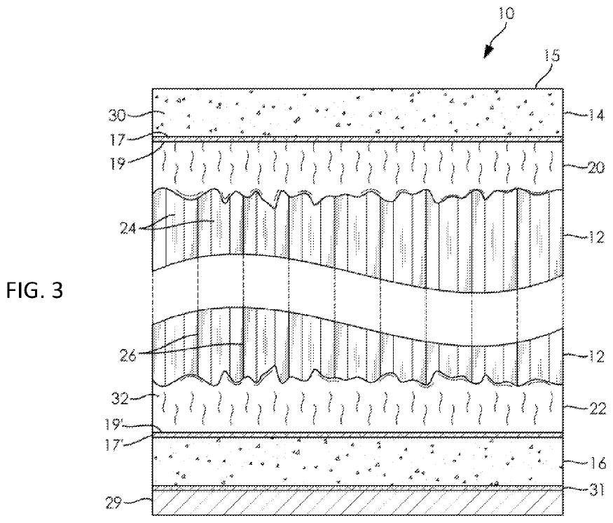

As shown in FIG. 2, a portion of the surface sheet 14 is cutaway to reveal the adhesive 20, a cloth, if present; and the open area core 12. The surface sheet 14 is adhered to a first side of the open area core 12 by a first adhesive layer 20. According to embodiments, the surface sheet 14 presents an outwardly facing high gloss surface 15. FIG. 3 is an enlarged cross-sectional view of a composite sandwich panel material 10 used to form the inventive vehicle component construct 52, 52′, and 52″ according to embodiments of the invention. FIG. 3 shows further details of the various layers making up the composite sandwich panel material 10. In some embodiments, a cloth 19 is present intermediate between the face 17 of the open area core 12 and the surface sheet 14, the cloth 19 being embedded within the adhesive 20. The structural skin 16 is adhered to an opposing second side of the open area core 12 by a second adhesive layer 22. In some embodiments, a cloth 19′ is present intermediate between the face 17′ of open area core 12 and the structural skin 16, the cloth 19′ being embedded within the adhesive 22.

According to embodiments, the open area core 12 is formed of a lightweight material that defines a plurality of pores 24 so as to reduce the overall density of the open area core 12. The open area core 12 is formed from a variety of materials that include cellulosics such as corrugated fiberboard, paper board, paper stock; thermoplastics such as poly(methyl methacrylate) (PMMA), acrylonitrile butadiene styrene (ABS), polyamides, polylactides, polybenzimidazoles, polycarbonates, polyether sulfones, polyethylene, polypropylene, polystyrene, polyvinyl chloride, and block copolymers of any one of the aforementioned where at least one of the aforementioned makes up the majority by weight of the copolymer and regardless of the tacticity of the polymer or copolymer; thermosets such as polyesters, polyureas, polyurethanes, polyurea/polyurethanes, epoxies, vinyl esters; metal such as aluminum, magnesium, and alloys of any one of the aforementioned where at least one of the aforementioned metals constitutes the majority by weight of the alloy; a foam formed from polyurethane, polyethylene, ethylene vinyl acetate, polypropylene, polystyrene, polyvinyl chloride, oraerogels, regardless of whether the foam is open-celled or closed-celled. The top edges of the walls 26 that define the pores 24 in certain embodiments of the open area core such as 12 form an array of various shapes, such as hexagonal, circular, rhomboidal, triangular, parallelogram quadrilateral, and regular quadrilateral, honeycombs, diamonds, squares, triangles, parallelograms, circles, or a combination thereof. In some embodiments, the ratio of the thickness of a wall 26 to the maximal linear extent between faces 17 and 17′ is between 0.01-10:1. A wall thickness ranges from 0.1 mm to 100 mm in such embodiments.

The adhesive layers 20, 22 are formed of either a thermoplastic or curable formulation, a polyurethane or polyurethane prepolymer adhesive, which may be in the form of glue, a moisture cure adhesive, a reactive hot melt adhesive, or a polyurethane resin. As shown in FIG. 3, due to the compressive force applied to the adhesive layers 20, 22 between the surface sheet 14 and the open area core 12 and the structural skin 16 and the open area core 12, the adhesive 20, 22 is engineered to have an initial viscosity on contact with the face 17 and the walls 26 so as partially fill the pores 24 of the open area core 12. The viscosity of the adhesive layers 20, 22 ensures that the adhesive does not excessively run into the pores defined in the open area core before the adhesive attains final strength. Accordingly, the adhesive surface area for adhesion between a surface sheet and structural skin and the open area core is at least 5% more than surface area of the walls at the face. This increased surface area of adhesion reduces delamination of the components of the composite sandwich 10 and surprisingly allows for the use of thinner surface sheets that do not exhibit bond line read through. As a result of increasing the adhesive surface area coverage from 10 to 50 surface area percent allows for the comparatively expensive high gloss surface sheet to be reduced in thickness from 1.5 mm to between 1.3 and 0.8 mm while still preventing of bond line read through.

The high gloss surface sheet 14 of the composite sandwich panel 10 is formed from sheet molding compound (SMC), thermoplastic, dicyclopentadiene (DCPD), overmolded polyurethane (PU), or a combination thereof. According to embodiments, the surface sheet 14 is a high gloss surface sheet having a high gloss surface 15. The surface sheet 14 can include a filler material 30 to reinforce and/or serve to decrease the weight of the high gloss surface sheet 14. The filler material 30 is any of glass fibers, carbon fibers, natural fibers, hollow or solid glass microspheres, or a combination thereof. The fibers may be oriented or non-oriented. In some inventive embodiments in which SMC forms the high gloss surface, a resin package sold by Continental Structural Plastics, Inc. under the tradenames TCA® and TCA® ULTRA-LITE™ are used herein. Exemplary formulations of which are detailed in U.S. Pat. No. 7,700,670; WO2017/184761; and U.S. Pat. No. 7,524,547B2. It is appreciated that the high gloss sheet routinely includes additives to retain dimensionality. Such additives routinely including glass fiber; carbon fiber; inorganic particulate fillers such as calcium carbonate, talc, and carbon black; glass microspheres; carbon nanotubes; graphene; low profile additives; moisture scavengers; and combinations thereof. Typical thicknesses of the high gloss surface sheet in the present invention range from 0.5 to 5 millimeters (mm) without regard to edges.

According to embodiments, a colorant is added to the sheet molding compound (SMC), thermoplastic, dicyclopentadiene (DCPD), overmolded polyurethane (PU), or a combination thereof that forms the high gloss surface sheet 14 of the composite sandwich panel 10. Thus, the exterior surface of a vehicle component construct 52, 52′, and 52″ formed of such a composite sandwich panel 10 is provided with the color of the vehicle exterior, thereby eliminating additional component finishing processes, such as priming and painting.

As will be understood by a person having ordinary skill in the art, the high gloss surface sheet tends to be a comparatively dense component and an expensive portion to manufacture given the materials used and necessary forming processes to maintain minimal perceptible surface defects suitable for a Class A autobody part. To reduce costs and weight of the composite sandwich panel material 10, it is accordingly desirable to reduce the thickness of the high gloss surface sheet 14, making it as thin as possible. It will also be understood that as the thickness of the high gloss surface sheet 14 is decreased the high gloss surface sheet 14 tends to deform when supported by limited portions of the face 17 above the open area core 12. While result to a large contact surface area of the first adhesive layer 20 is advantageous, in some inventive embodiments a cloth 19 is embedded in the first adhesive layer 20.

The structural skin 16 is adhered to the second side of the open area core 12 by the second adhesive layer 22. The structural skin 16 is formed of a fiber mat having non-oriented, non-woven fibers, unidirectional, or woven fibers, a thermoplastic sheet, or an SMC. The structural skin 16 provides a robust and durable surface. In some embodiments, the structural skin 16 terminates against the backside of the surface sheet 14 to encapsulate the open area core 12.

According to certain embodiments, the composite sandwich panel material 10 provides sound damping, fire retardancy, thermal insulation, or a combination thereof by placing a sound and/or heat absorbing material within the pores 24 of the open area core 12. According to embodiments, the pores 24 of the open area core 12 are at least partially filled with a fill 49. The fill illustratively including foam pellets, fire retardant, or a phase change material. Phase change materials operative herein include waxes or an inorganic salt hydrates.

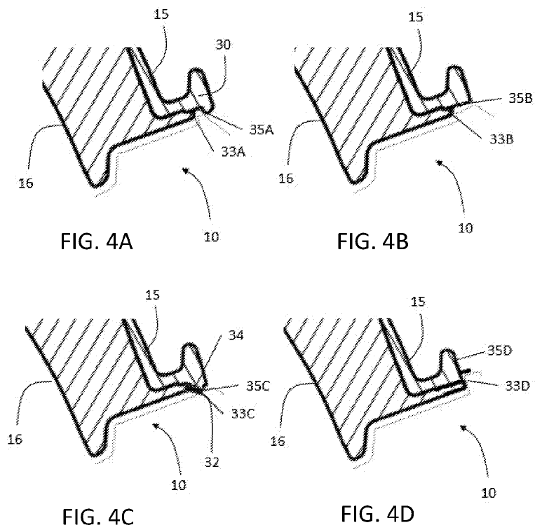

The surface sheet 14 and the structural skin 16 are joined together along an edge 33A-33D of the composite sandwich panel material 10 to form a seal, as shown in FIGS. 4A-4D, respectively. In certain embodiments in which all of the edges of the composite sandwich panel assembly 10 are sealed, the open area core 12 is fully enclosed and moisture is inhibited from entering the interior of the composite sandwich panel assembly 10. Given that the components of the inventive vehicle component construct 52, 52′, and 52″ formed of the composite sandwich panel assembly 10 are exposed to natural elements including sun, snow, humidity, and rain, preventing moisture from entering the interior of the composite sandwich panel material 10 is important given that freeze thaw cycles of moisture within the part cause expansion and potentially failure of the composite sandwich panel material 10, leading to damage to the vehicle component construct 52, 52′, and 52″. Additionally, in embodiments in which the open area core 12 is formed of a hydrophilic material such as paper, moisture within the composite sandwich panel assembly 10 would destroy the open are core 12 and cause the part to fail.

FIGS. 4A-4D show various embodiments of ways in which the surface sheet 14 and the structural skin 16 are joined together to form a sealed edge 33A-33D, respectively according to the present disclosure. In some inventive embodiments an elastomeric gasket 34 is disposed between the surface sheet 14 and the structural skin 16 at the 33C to make the edge 33C more water resistant. It is appreciated that a gasket is readily included in the other edge joinder 33A, 33B, and 33D. The gasket 35 enhances maintenance of the edge seal over a wider range of use conditions.

As will be understood by one having ordinary skill in the art, to form an edge seal between the surface sheet 14 and the structural skin 16, at least one of the surface sheet 14 and the structural skin 16 requires enough material to wrap around the edge of the composite sandwich 10. According to embodiments, at least one of the surface sheet 14 and the structural skin 16 is provided in dimensions greater than the dimensions of the final composite part such that the material is able to wrap around the final edge composite sandwich 10. According to certain embodiments, the at least one of the surface sheet 14 and the structural skin 16 is preformed such that it has edges extending generally perpendicularly from the plane of the sheet material.

According to embodiments, excess material is cut from the composite sandwich once the edge seal is formed. As shown in FIG. 4A, excess material of the structural skin 16 has been trimmed from the composite sandwich assembly 10 by a knife or router that presses against the divot 35A that is formed by the surface sheet 14. In FIG. 4B, the edge 33B formed by removing excess material for tool engagement against a shoulder 35B of the surface sheet 14. In FIG. 4C, the edge 33C formed by removing excess material for tool engagement against a shoulder 35C of the surface sheet 14. Also, as shown in FIG. 4D, excess material of one or both the surface sheet 14 and the structural skin 16 are trimmed with tool pressure against shoulder 35D.

Given that the surface sheet 14 and the structural skin 16 of the composite sandwich panel material 10 are joined together to form sealed edges 33A-33D, thereby protecting the open area core 12 within the surface sheet 14 and the structural skin 16, embodiments of the inventive vehicle component construct 52, 52′, 52″ may be submerged in paint for finishing. According to embodiments, the vehicle component construct 52, 52′, and 52″ is e-coated, that is the vehicle component construct 52, 52′, and 52″ is submerged in an electrically charged coating that is attracted to the high gloss surface 14 to evenly coat the vehicle component construct 52, 52′, and 52″.

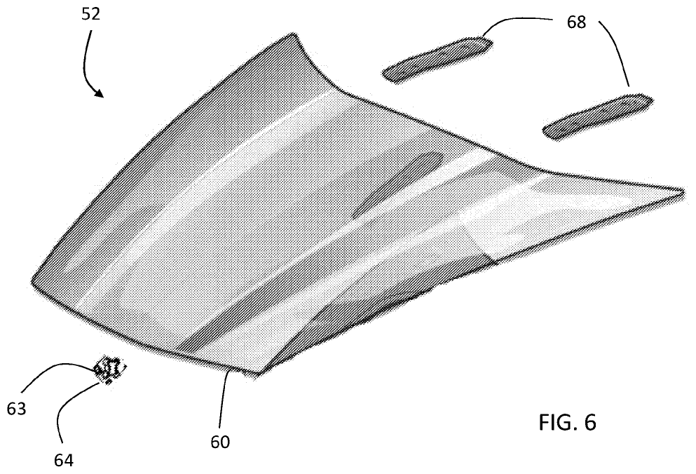

Referring again to FIG. 1, embodiments of an inventive vehicle component include a vehicle component construct hood 52, roof structure 52′, and body panel 52″. As shown in FIG. 6, embodiments of a hood 52 include a locking mechanism 64. The locking mechanism 64 is positioned on the interior surface 60 of the hood 52 that is defined by the structural skin 16 of the composite sandwich panel material 10. According to embodiments, the locking mechanism is attached to the hood 52 is shaped and formed, which may include cutting an opening in the interior surface 60 of the hood that corresponds to the shape and desired location of the locking mechanism 64. The locking mechanism 64 may include a latch and a catch that are configured to cooperate with one another in order to hold the hood 52 in a closed position relative to the vehicle frame. According to embodiments, the hood 52 includes a handle 63 positioned on the interior surface 60 of the hood 52. The handle 63 being configured to actuate the locking mechanism 64.

According to embodiments, a hood 52 includes a plurality of hinges 68 that movably attach the hood 52 to the vehicle frame. According to embodiments, the hinges 68 are attached to the interior surface 60 of the composite construct 52. According to embodiments, the interior surface 60 of the composite construct 52 includes a plurality of cutouts that correspond in shape and desired location to the hinges 68. Such cutouts are formed in the interior surface 60 of the composite construct 52 by either cutting the cutouts out from the material of the interior surface 60 of the composite construct 52 or by forming the cutouts in the frame by molding when the interior surface 60 of the composite construct 52 is formed. According to embodiments, the cutouts are positioned along an edge of the interior surface 60 of the composite construct 52, as shown in FIG. 6. In such a case, the hood 52 pivots about the hinges 68 to move upward to an open position.

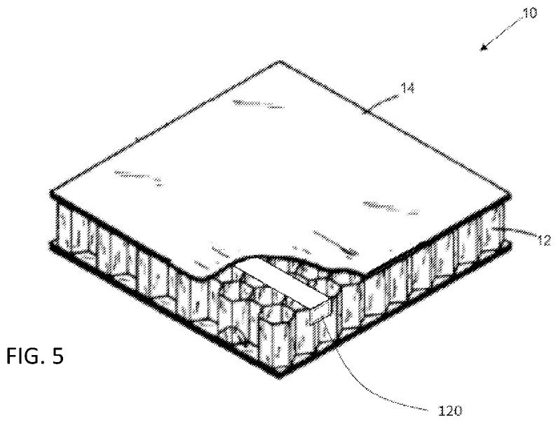

As shown in FIG. 5, embodiments of an inventive vehicle component construct 52, 52′, 52″ include a conduit system 120 embedded within the composite sandwich panel material 10 of the vehicle component. As shown in FIG. 5, the conduit system 120 is embedded in the open area core 12 of composite sandwich panel assembly 10 that forms the vehicle component construct 52, 52′, 52″. According to embodiments, the conduit system 120 comprises tubing or wires that are molded into the open area core 12 of the composite sandwich 10 before the vehicle component is formed. According to embodiments, the conduit system 120 includes electrical wiring, ventilation ducts, or heating elements. Accordingly, embodiments of the inventive hood 52, a roof structure 52′, or body panel 52″ are capable of including features such as speakers, lights, air vents for regulating the climate within the vehicle, and defrosting elements for removing ice or snow present on the vehicle component. The conduit systems 120 of various vehicle components are configured to align with one another to form a single connected conduit system throughout the vehicle to connect electrical wiring, ventilation ducts, and/or heating elements of each of an inventive vehicle component with like electrical wiring, ventilation ducts, and/or heating elements of the vehicle to function.

According to embodiments of hood 52 includes a safety cable 51 that is configured to be attached between the hood 52 and the vehicle body. According to embodiments, the safety cable 51 is embedded in the hood 52 at a first end of the safety cable 51 and is attachable at the opposite end of the safety cable 51 to the frame of the vehicle body. The safety cable 51 thus connects the hood 52 to the vehicle body at a point in addition to the hinges 68. Thus, in the event of a crash or failure of the hinges 68, the hood 52 is remains connected to the vehicle body.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention but is not meant to be a limitation upon the practice thereof. The following claims, including all equivalents thereof, are intended to define the scope of the invention.

1. A vehicle component construct comprising:
a panel formed of a composite sandwich material comprising an open area core defining a plurality of pores, a high gloss surface sheet adhered to a first face of the open area core by a first adhesive layer, and a structural skin adhered to a second face of the open area core by a second adhesive layer.

2. The vehicle component construct of claim 1 wherein the exterior surface of said panel is defined by the high gloss surface sheet of said composite sandwich panel material and the oppositely opposed interior surface of said panel is defined by the structural skin of said composite sandwich material.

3. The vehicle component construct of claim 1 further comprising any of a locking mechanism positioned on an interior surface of said panel, a handle positioned on an interior surface of said panel, a plurality of hinges attached to an interior surface of said panel.

4. The vehicle component construct of claim 1 wherein the open area core of said composite sandwich material is an array.

5. The vehicle component construct of claim 1 wherein the open are core of said composite sandwich material is formed of at least one of: cellulosics, thermoplastic, thermoset, metal, or foam.

6. The vehicle component construct of claim 1 wherein the high gloss surface sheet of said composite sandwich 1 material is formed of any one of: sheet molding compound (SMC), thermoplastic sheet, dicyclopentadiene (DCPD), or overmolded polyurethane (PU).

7. The vehicle component construct of claim 1 wherein the high gloss surface sheet of said composite sandwich material further comprises a filler.

8. The vehicle component construct of claim 1 wherein the high gloss surface sheet of said composite sandwich material further comprises a colorant.

9. The vehicle component construct of claim 1 wherein the high gloss surface sheet of said composite sandwich material has a thickness of from 0.5 to 3.5 mm.

10. The vehicle component construct of claim 1 wherein said composite sandwich material has a ratio of a thickness of the high gloss surface sheet to a thickness of the open area core of 0.01-1:1.

11. The vehicle component construct of claim 1 wherein said composite sandwich material has a cloth intermediate between the high gloss surface sheet and the open area core.

12. The vehicle component construct of claim 11 wherein the cloth is embedded in the first adhesive layer and the surface sheet is an SMC that has a thickness of less than 1.5 mm and still has a high gloss surface.

13. The vehicle component construct of claim 1 wherein the first adhesive layer of said composite sandwich material contacts an interior volume of the open area core.

14. The vehicle component construct of claim 1 wherein the structural skin is formed of a fiber mat.

15. The vehicle component construct of claim 1 wherein the first adhesive layer of said composite sandwich material and the second adhesive layer of said composite sandwich material each independently are a polyurethane or polyurethane prepolymer, a moisture cure adhesive, a reactive hot melt adhesive, or polyurethane resin.

16. The vehicle component construct of claim 1 wherein said composite sandwich material has a fill in the pores of the open area core, the fill being at least one of a sound dampening foam, a fire retardant, or a phase change material.

17. The vehicle component construct of claim 1 further comprising a decorative layer attached to said structural skin.

18. The vehicle component construct of claim 1 wherein the high gloss surface sheet of said composite sandwich material and the structural skin of said composite sandwich material are joined together to form an edge defining a moisture resistant seal.

19. The vehicle component construct of claim 18 further comprising a gasket disposed between the high gloss surface sheet of said composite sandwich material and the structural skin at the edge.

20. The vehicle component construct of claim 1 wherein the high gloss surface sheet of said composite sandwich material is SMC with an average thickness of from 1.5 to 5 mm and the open area core of said composite sandwich material has a pore diameter of 6 to 25 mm.
